(19) United States
(12) Patent Application Publication
(10) Pub. No.: US 2012/0306836 A1
(43) Pub. Date: Dec. 6, 2012

(54) Apparatus, System and Method for an Electro-Luminance Display on a Garment

(76) Inventor: Farrell Ackerman, Delray Beach, FL (US)

(21) Appl. No.: 13/151,241

(22) Filed: Jun. 1, 2011

(51) Int. Cl. G09G 3/30; G06F 3/038

(52) U.S. Cl. 345/211; 345/76; 704/E11.001

(57) ABSTRACT

Various apparatus, systems and methods for an electro-luminance display on a garment are described. An apparatus comprises an electro-luminance portion being configured to display a graphic image. The electro-luminance portion is further configured to removably join to an outside surface of the garment. A housing is configured to removably join to a back side of the electro-luminance portion. A processor is contained within the housing and coupled to the electro-luminance portion. The processor is configured to control functions of the electro-luminance portion. A transceiver system comprises a receiver contained within the housing. The receiver is configured to receive GPS location information and communicate the GPS location information to the processor where the processor is operable to control the electro-luminance portion based in part on the GPS location information. A rechargeable power source is contained within the housing to provide power to the electro-luminance portion and components within the housing.

### FEDERALLY SPONSORED RESEARCH OR DEVELOPMENT

Not applicable.

### REFERENCE TO SEQUENCE LISTING, A TABLE, OR A COMPUTER LISTING APPENDIX

Not applicable.

### COPYRIGHT NOTICE

A portion of the disclosure of this patent document contains material that is subject to copyright protection. The copyright owner has no objection to the facsimile reproduction by anyone of the patent document or patent disclosure as it appears in the Patent and Trademark Office, patent file or records, but otherwise reserves all copyright rights whatsoever.

### FIELD OF THE INVENTION

One or more embodiments of the invention generally relate to luminance associated with apparel. More particularly, the invention relates to a self-contained electro-luminance system for presentation of an illuminated image.

### BACKGROUND OF THE INVENTION

Illumination of apparel provides consumers with opportunities for displaying highly visible and colorful images.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 illustrates an example electro-luminance system, in accordance with an embodiment of the present invention;

FIG. 2 illustrates example shirt as discussed with reference to FIG. 1, with electro-luminance device removed, in accordance with an embodiment of the present invention;

FIG. 3 illustrates an example process for attachment and removal of an electro-luminance device to/from a shirt, in accordance with an embodiment of the present invention;

FIG. 4 presents an example right-side view as described with reference to FIG. 1 for attachment and removal of electro-luminance device to/from shirt, in accordance with an embodiment of the present invention;

FIG. 5 presents an example left-side view as described with reference to FIG. 1 for attachment and removal of electro-luminance device to/from shirt, in accordance with an embodiment of the present invention;

FIG. 6 presents an example bottom view as described with reference to FIG. 1 for a containment device, in accordance with an embodiment of the present invention;

FIG. 7 illustrates an example containment portion detached from a luminance generating portion with a cable connected between the containment portion and the luminance generating portion, in accordance with an embodiment of the present invention;

FIG. 8 illustrates an example for connecting a source of power for powering electronic equipment located internal to a containment portion and/or for charging a battery located internal to containment portion, in accordance with an embodiment of the present invention;

FIG. 9 illustrates an example control portion for controlling the operation of a luminance generation portion, in accordance with an embodiment of the present invention;

FIG. 10 presents an example photograph for a top view of a control portion, in accordance with an embodiment of the present invention;

FIG. 11 presents an example photograph for a bottom view of a control portion, in accordance with an embodiment of the present invention;

FIG. 12 presents an example photograph for elements of a containment portion, in accordance with an embodiment of the present invention;

FIG. 13 presents an example photograph for the top view of the electro-luminance device as described with reference to FIG. 1;

FIG. 14 presents an example photograph for the bottom view of the electro-luminance device as described with reference to FIG. 1;

FIG. 15 illustrates an example method for operation of a electro-luminance system, in accordance with an embodiment of the present invention; and

FIG. 16 illustrates a mobile device that, when appropriately configured or designed, may serve as a mobile device for which the present invention may be embodied.

Unless otherwise indicated illustrations in the figures are not necessarily drawn to scale.

### SUMMARY OF THE INVENTION

To achieve the forgoing and other objects and in accordance with the purpose of the invention, a variety of apparatus, systems and methods for an electro-luminance display on a garment are described.

In one embodiment an apparatus comprises an electro-luminance portion being configured to display a graphic image. The electro-luminance portion is further configured to removably join to an outside surface of a garment. A housing is configured to removably join to a back side of the electro-luminance portion. A processor is contained within the housing and coupled to the electro-luminance portion. The processor being configured to execute a plurality of instructions and to control functions of the electro-luminance portion. A transceiver system comprises an antenna and a receiver contained within the housing. The receiver being configured to at least receive GPS location information from the antenna and communicate the GPS location information to the processor where the processor is operable to control the electro-luminance portion based in part on the GPS location information. A rechargeable power source is contained within the housing to provide power to the electro-luminance portion and components within the housing. Another embodiment further comprises a microphone system being contained within the housing. The microphone system being operable to at least detect verbal commands and communicate the verbal commands to the processor. Yet another embodiment further comprises an adjustment mechanism being operable to signal the processor to adjust a sensitivity of the microphone system. In still another embodiment the adjustment mechanism is further operable to signal the processor to adjust a luminance output of the electro-luminance portion. In another embodiment the processor is operable to change a presentation displayed by the electro-luminance portion in response to a location determined from the GPS information. In yet another embodiment the processor is operable to change a presentation displayed by the electro-luminance portion in response to a change of location determined from the GPS information. In still another embodiment the processor is operable to change a presentation displayed by the electro-luminance portion in response to a rate of change of location determined from the GPS information. In another embodiment the processor is operable to change a presentation displayed by the electro-luminance portion in response to a change in a rate of change of location determined from the GPS information. In yet another embodiment the receiver is further configured to receive commands from a wireless device and communicate the commands to the processor. Still another embodiment further comprises an indicator joined to the housing for indicating a status of the rechargeable power source.

In another embodiment a system comprises a garment having an outside surface being visible to onlookers. A first joining mechanism comprises a first part and a second part. The first part being joined to the outside surface. An electro-luminance display comprises a front side and a back side. The electro-luminance display being configured to display a graphic image. The second part of the first joining mechanism is joined to the back side where the electro-luminance display is further operable to removably join to the outside surface by joining the first and second parts of the first joining mechanism. A second joining mechanism comprises a first part and a second part. The first part being joined to the back side. A housing comprises front portion, back portion and an interior. The second part of the second joining mechanism being joined to the front portion where the housing is further operable to removably join to the back side by joining the first and second parts of the second joining mechanism. A processor is contained within the interior and coupled to the electro-luminance portion. The processor being configured to execute a plurality of instructions and to control functions of the electro-luminance portion. A microphone system is contained within the interior. The microphone system being operable to at least detect verbal commands and communicate the verbal commands to the processor. A transceiver system comprises an antenna and a receiver contained within the interior. The receiver being configured to at least receive GPS location information from the antenna and communicate the GPS location information to the processor where the processor is operable to control the electro-luminance portion based in part on the GPS location information. The receiver being further configured to receive commands from a wireless device and communicate the commands to the processor. A rechargeable power source is contained within the interior to provide power to the electro-luminance portion and components within the housing. Another embodiment further comprises an adjustment mechanism being operable to signal the processor to adjust a sensitivity of the microphone system. In yet another embodiment the adjustment mechanism is further operable to signal the processor to adjust a luminance output of the electro-luminance portion. In still another embodiment the processor is operable to change a presentation displayed by the electro-luminance portion in response to a location determined from the GPS information. In another embodiment the processor is operable to change a presentation displayed by the electro-luminance portion in response to a change of location determined from the GPS information. In yet another embodiment the processor is operable to change a presentation displayed by the electro-luminance portion in response to a rate of change of location determined from the GPS information. In still another embodiment the processor is operable to change a presentation displayed by the electro-luminance portion in response to a change in rate of change of location determined from the GPS information. Another embodiment further comprises an indicator joined to the housing for indicating a status of the rechargeable power source. Yet another embodiment further comprises a USB connection being operable to charge the rechargeable power source.

In another embodiment a method comprises a step of receiving an audio command where processing of the audio command results in an operational control of an electro-luminance display system being removably joined to an outside surface of a garment visible to onlookers. The method further comprises a step of receiving GPS location information where processing of the GPS location information results in a change in operational control of the electro-luminance display system. The method further comprises receiving a wireless command where processing of the wireless command results in an operational control of the electro-luminance display system.

Other features, advantages, and objects of the present invention will become more apparent and be more readily understood from the following detailed description, which should be read in conjunction with the accompanying drawings.

### DETAILED DESCRIPTION OF THE PREFERRED EMBODIMENTS

The present invention is best understood by reference to the detailed figures and description set forth herein.

Embodiments of the invention are discussed below with reference to the Figures. However, those skilled in the art will readily appreciate that the detailed description given herein with respect to these figures is for explanatory purposes as the invention extends beyond these limited embodiments. For example, it should be appreciated that those skilled in the art will, in light of the teachings of the present invention, recognize a multiplicity of alternate and suitable approaches, depending upon the needs of the particular application, to implement the functionality of any given detail described herein, beyond the particular implementation choices in the following embodiments described and shown. That is, there are numerous modifications and variations of the invention that are too numerous to be listed but that all fit within the scope of the invention. Also, singular words should be read as plural and vice versa and masculine as feminine and vice versa, where appropriate, and alternative embodiments do not necessarily imply that the two are mutually exclusive.

It is to be further understood that the present invention is not limited to the particular methodology, compounds, materials, manufacturing techniques, uses, and applications, described herein, as these may vary. It is also to be understood that the terminology used herein is used for the purpose of describing particular embodiments only, and is not intended to limit the scope of the present invention. It must be noted that as used herein and in the appended claims, the singular forms “a,” “an,” and “the” include the plural reference unless the context clearly dictates otherwise. Thus, for example, a reference to “an element” is a reference to one or more elements and includes equivalents thereof known to those skilled in the art. Similarly, for another example, a reference to “a step” or “a means” is a reference to one or more steps or means and may include sub-steps and subservient means. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

Unless defined otherwise, all technical and scientific terms used herein have the same meanings as commonly understood by one of ordinary skill in the art to which this invention belongs. Preferred methods, techniques, devices, and materials are described, although any methods, techniques, devices, or materials similar or equivalent to those described herein may be used in the practice or testing of the present invention. Structures described herein are to be understood also to refer to functional equivalents of such structures. The present invention will now be described in detail with reference to embodiments thereof as illustrated in the accompanying drawings.

From reading the present disclosure, other variations and modifications will be apparent to persons skilled in the art. Such variations and modifications may involve equivalent and other features which are already known in the art, and which may be used instead of or in addition to features already described herein.

Although Claims have been formulated in this Application to particular combinations of features, it should be understood that the scope of the disclosure of the present invention also includes any novel feature or any novel combination of features disclosed herein either explicitly or implicitly or any generalization thereof, whether or not it relates to the same invention as presently claimed in any Claim and whether or not it mitigates any or all of the same technical problems as does the present invention.

Features which are described in the context of separate embodiments may also be provided in combination in a single embodiment. Conversely, various features which are, for brevity, described in the context of a single embodiment, may also be provided separately or in any suitable subcombination. The Applicants hereby give notice that new Claims may be formulated to such features and/or combinations of such features during the prosecution of the present Application or of any further Application derived therefrom.

References to “one embodiment,” “an embodiment,” “example embodiment,” “various embodiments,” etc., may indicate that the embodiment(s) of the invention so described may include a particular feature, structure, or characteristic, but not every embodiment necessarily includes the particular feature, structure, or characteristic. Further, repeated use of the phrase “in one embodiment,” or “in an exemplary embodiment,” do not necessarily refer to the same embodiment, although they may.

As is well known to those skilled in the art many careful considerations and compromises typically must be made when designing for the optimal manufacture of a commercial implementation any system, and in particular, the embodiments of the present invention. A commercial implementation in accordance with the spirit and teachings of the present invention may configured according to the needs of the particular application, whereby any aspect(s), feature(s), function(s), result(s), component(s), approach(es), or step(s) of the teachings related to any described embodiment of the present invention may be suitably omitted, included, adapted, mixed and matched, or improved and/or optimized by those skilled in the art, using their average skills and known techniques, to achieve the desired implementation that addresses the needs of the particular application.

In the following description and claims, the terms “coupled” and “connected,” along with their derivatives, may be used. It should be understood that these terms are not intended as synonyms for each other. Rather, in particular embodiments, “connected” may be used to indicate that two or more elements are in direct physical or electrical contact with each other. “Coupled” may mean that two or more elements are in direct physical or electrical contact. However, “coupled” may also mean that two or more elements are not in direct contact with each other, but yet still cooperate or interact with each other.

A “computer” may refer to one or more apparatus and/or one or more systems that are capable of accepting a structured input, processing the structured input according to prescribed rules, and producing results of the processing as output. Examples of a computer may include: a computer; a stationary and/or portable computer; a computer having a single processor, multiple processors, or multi-core processors, which may operate in parallel and/or not in parallel; a general purpose computer; a supercomputer; a mainframe; a super mini-computer; a mini-computer; a workstation; a micro-computer; a server; a client; an interactive television; a web appliance; a telecommunications device with internet access; a hybrid combination of a computer and an interactive television; a portable computer; a tablet personal computer (PC); a personal digital assistant (PDA); a portable telephone; application-specific hardware to emulate a computer and/or software, such as, for example, a digital signal processor (DSP), a field-programmable gate array (FPGA), an application specific integrated circuit (ASIC), an application specific instruction-set processor (ASIP), a chip, chips, a system on a chip, or a chip set; a data acquisition device; an optical computer; a quantum computer; a biological computer; and generally, an apparatus that may accept data, process data according to one or more stored software programs, generate results, and typically include input, output, storage, arithmetic, logic, and control units.

“Software” may refer to prescribed rules to operate a computer. Examples of software may include: code segments in one or more computer-readable languages; graphical and or/textual instructions; applets; pre-compiled code; interpreted code; compiled code; and computer programs.

A “computer-readable medium” may refer to any storage device used for storing data accessible by a computer. Examples of a computer-readable medium may include: a magnetic hard disk; a floppy disk; an optical disk, such as a CD-ROM and a DVD; a magnetic tape; a flash memory; a memory chip; and/or other types of media that can store machine-readable instructions thereon.

A “computer system” may refer to a system having one or more computers, where each computer may include a computer-readable medium embodying software to operate the computer or one or more of its components. Examples of a computer system may include: a distributed computer system for processing information via computer systems linked by a network; two or more computer systems connected together via a network for transmitting and/or receiving information between the computer systems; a computer system including two or more processors within a single computer; and one or more apparatuses and/or one or more systems that may accept data, may process data in accordance with one or more stored software programs, may generate results, and typically may include input, output, storage, arithmetic, logic, and control units.

A “network” may refer to a number of computers and associated devices that may be connected by communication facilities. A network may involve permanent connections such as cables or temporary connections such as those made through telephone or other communication links. A network may further include hard-wired connections (e.g., coaxial cable, twisted pair, optical fiber, waveguides, etc.) and/or wireless connections (e.g., radio frequency waveforms, free-space optical waveforms, acoustic waveforms, etc.). Examples of a network may include: an internet, such as the Internet; an intranet; a local area network (LAN); a wide area network (WAN); and a combination of networks, such as an internet and an intranet.

Exemplary networks may operate with any of a number of protocols, such as Internet protocol (IP), asynchronous transfer mode (ATM), and/or synchronous optical network (SONET), user datagram protocol (UDP), IEEE 802.x, etc.

Embodiments of the present invention may include apparatuses for performing the operations disclosed herein. An apparatus may be specially constructed for the desired purposes, or it may comprise a general-purpose device selectively activated or reconfigured by a program stored in the device.

Embodiments of the invention may also be implemented in one or a combination of hardware, firmware, and software. They may be implemented as instructions stored on a machine-readable medium, which may be read and executed by a computing platform to perform the operations described herein.

In the following description and claims, the terms “computer program medium” and “computer readable medium” may be used to generally refer to media such as, but not limited to, removable storage drives, a hard disk installed in hard disk drive, and the like. These computer program products may provide software to a computer system. Embodiments of the invention may be directed to such computer program products.

An algorithm is here, and generally, considered to be a self-consistent sequence of acts or operations leading to a desired result. These include physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers or the like. It should be understood, however, that all of these and similar terms are to be associated with the appropriate physical quantities and are merely convenient labels applied to these quantities.

Unless specifically stated otherwise, and as may be apparent from the following description and claims, it should be appreciated that throughout the specification descriptions utilizing terms such as “processing,” “computing,” “calculating,” “determining,” or the like, refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices.

In a similar manner, the term “processor” may refer to any device or portion of a device that processes electronic data from registers and/or memory to transform that electronic data into other electronic data that may be stored in registers and/or memory. A “computing platform” may comprise one or more processors.

A first embodiment of the present invention will be described which provides means and methods for providing an electro-luminance system. An electro-luminance portion may be incorporated into an article of clothing for presentation of illumination. Electro-luminance portion may be attached to article of clothing such that electro-luminance portion may be removed from article of clothing in order to perform laundry of article of clothing without damaging electro-luminance portion. Non-limiting examples for control elements of electro-luminance portion include power switch, indicator device, power connection, sensitivity adjustment and microphone. Electro-luminance portion may be powered by self-contained rechargeable battery. Rechargeable battery may be charged via connection to external power source. Control and configuration of electro-luminance system may be performed via receipt of audible commands.

In other embodiments of the present invention, a method and means for providing control of electro-luminance system via wireless means will be described. Electro-luminance system includes antenna and transceiver for receiving and transmitting information. Non-limiting examples for sources of information received by electro-luminance system include Global Positioning System (GPS) and external wireless control modules. Information received wirelessly may operate to control and configure electro-luminance system.

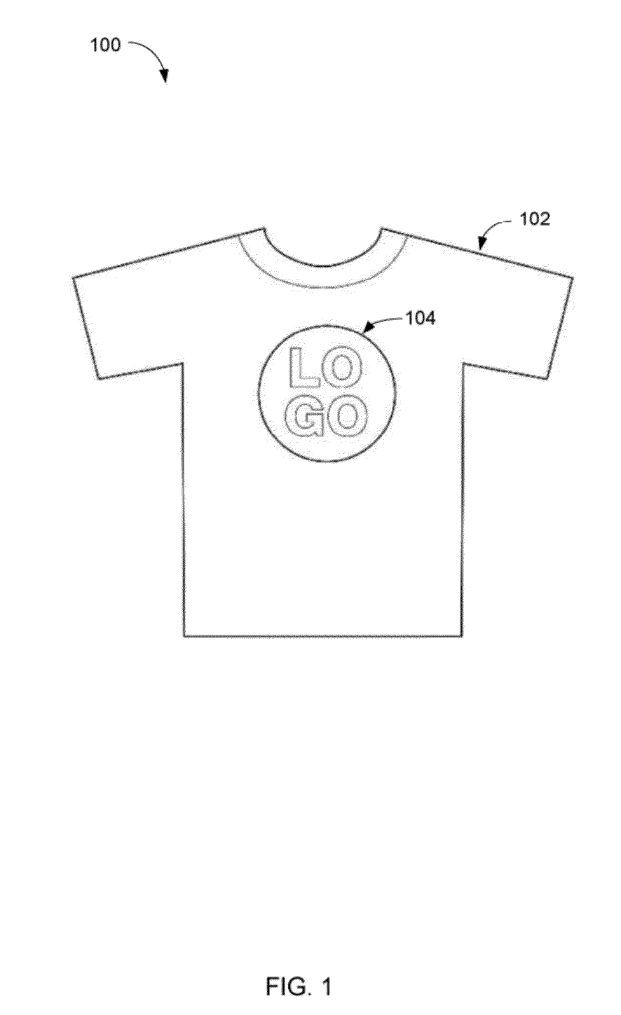

FIG. 1 illustrates an example electro-luminance system, in accordance with an embodiment of the present invention.

An electro-luminance system 100 includes a shirt 102 and an electro-luminance device 104.

The article of clothing presented for this example is a shirt; however, any known article of clothing may be used. Non-limiting examples for articles of clothing include shirt, pant, coat, hat and sock.

Shirt 102 functions as apparel for wearing. Electro-luminance device 104 operates to present an illuminated image for viewing.

Electro-luminance device 104 attaches to shirt 102 and may be removed from shirt 102. As a non-limiting example, electro-luminance device 104 may be removed from shirt 102 in order to laundry shirt 102. Furthermore, removal of electro-luminance device 104 while laundering shirt 102 prevents damage incurred to electro-luminance device 104 during the laundry process.

FIG. 1 illustrates an electro-luminance device presenting an illuminated image for viewing which may be attached and removed from a shirt.

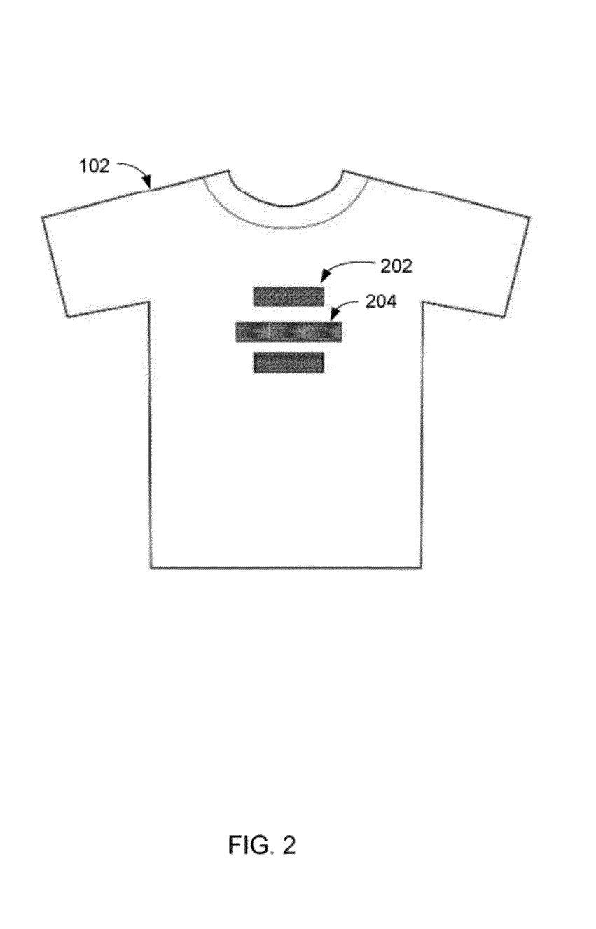

FIG. 2 illustrates example shirt as discussed with reference to FIG. 1, with electro-luminance device removed, in accordance with an embodiment of the present invention.

Shirt 102 includes a multiplicity of fastening devices with a sampling denoted as a fastening device 202 and a fastening device 204.

Fastening device 202 and fastening device 204 operate to fasten an electro-luminance device to shirt 102. Non-limiting examples for fastening device 202 and fastening device 204 include hook and loop devices. For example, if fastening device 202 is a hook device, then a loop device is attached to the electro-luminance device and vice-versa.

Non-limiting examples for methods of attaching fastening device 202 and fastening device 204 to shirt 102 include, sewing, taping and gluing.

FIG. 2 illustrates a shirt with fasting devices.

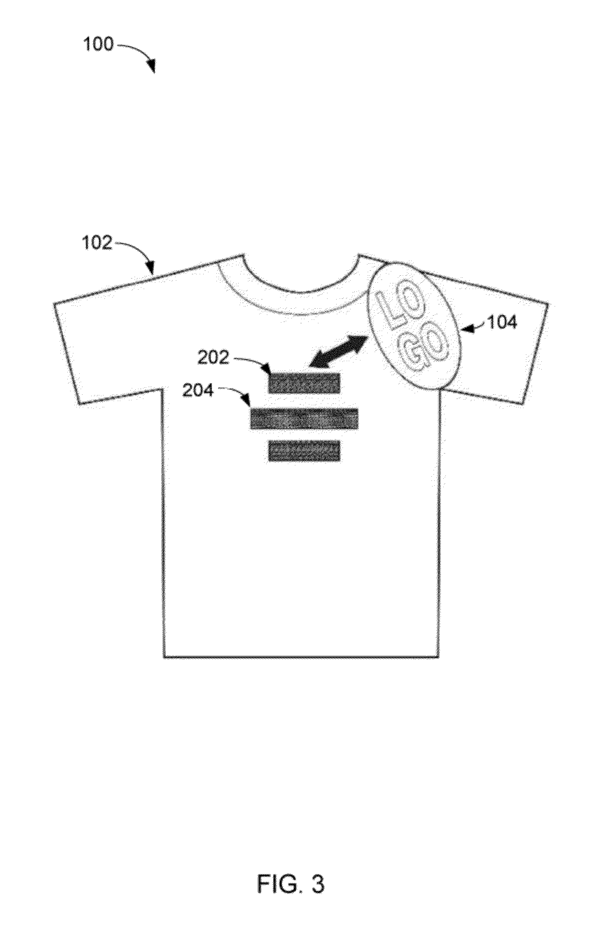

FIG. 3 illustrates an example process for attachment and removal of an electro-luminance device to/from a shirt, in accordance with an embodiment of the present invention.

Electro-luminance device 104 may be attached to shirt 102 via alignment of the fastening devices associated with shirt 102 to the fastening devices associated with electro-luminance device 104.

Electro-luminance device 104 may be removed from shirt 102 via application of sufficient force for removal.

FIG. 3 illustrates the process for removal/attachment of an electro-luminance device from a shirt.

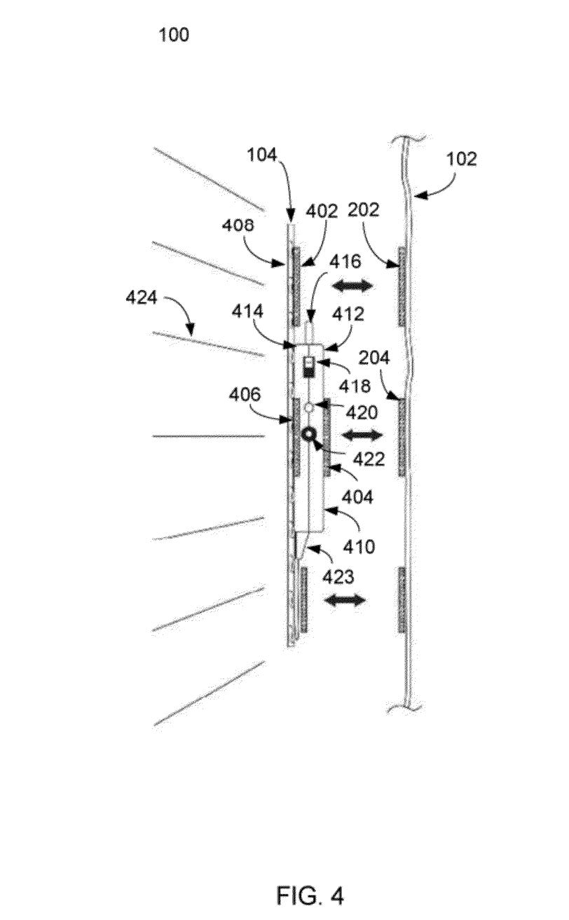

FIG. 4 presents an example right-side view as described with reference to FIG. 1 for attachment and removal of electro-luminance device to/from shirt, in accordance with an embodiment of the present invention.

Electro-luminance device 104 (FIG. 1) includes a fastening device 402, a fastening device 404, a fastening device 406, a luminance generating portion 408, a containment portion 410, a top containment portion 412, a bottom containment portion 414, a loop portion 416, a switch 418, an indicator portion 420 a power connection 422 and a cable 423.

Fastening device 402 operates to fasten electro-luminance device 104 to shirt 102 via connection to fastening device 202. Fastening device 404 operates to fasten electro-luminance device 104 to shirt 102 via connection to fastening device 204. As a non-limiting example, fastening device 402 and fastening device 404 may be performed via a hook or loop device. Fastening device 406 operates to fasten containment portion 410 to luminance generating portion 408. Non-limiting examples for fastening device 406 include hook, loop, glue and tape. Containment portion 410 operates to contain and protect electronic equipment located internally. Top containment portion 412 and bottom containment portion 414 operate to fasten together to form containment portion 410. Loop portion 416 provides a mechanism for mechanically removing containment portion 410 from luminance generating portion 408. Switch 418 provides a means for enabling or disabling the operation of the electronic equipment located internally to containment portion 410. Indicator portion 420 operates to provide a visual indicator for the operation of the electronic equipment located within containment portion 410. Non-limiting example of information communicated via indicator portion 420 include power on, power off, operational and stand-by-mode. Power connection 422 provides a means for connecting a power supply to the electronic equipment located internally to containment portion 410 for providing power and/or charging a battery. Cable 423 enables communication of information from the electronic equipment, located internal to containment portion 410, to luminance generating portion 408. A multiplicity of illumination beams emanates from luminance generating portion 408, with a sampling denoted as an illumination beam 424. Illumination beam 424 may be of any color, variation of color or pattern.

FIG. 4 presents a side view of a connection between an electro-luminance device and a shirt.

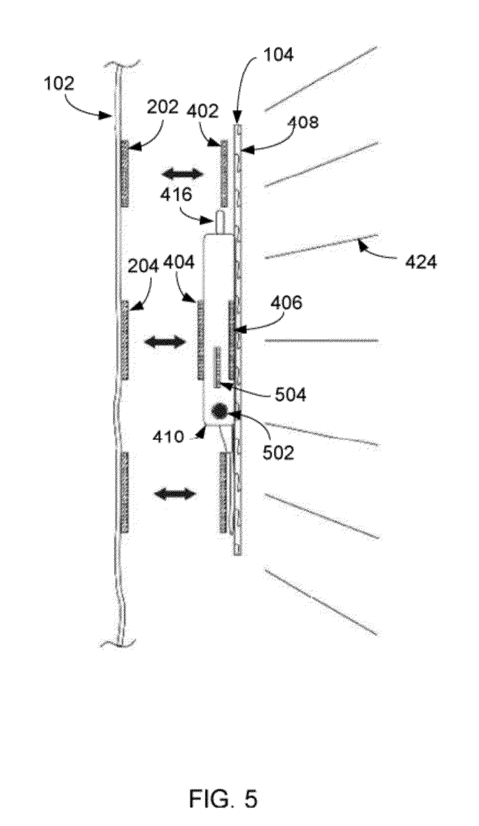

FIG. 5 presents an example left-side view as described with reference to FIG. 1 for attachment and removal of electro-luminance device to/from shirt, in accordance with an embodiment of the present invention.

Elements of FIG. 5 in common with FIG. 4 will not be described for FIG. 5. For elements of FIG. 5 in common with FIG. 4, the reader may refer to the discussion with reference to FIG. 4.

Containment portion 410 (FIG. 4) includes a microphone 502 and an adjustment mechanism 504.

Microphone 502 operates to receive sound waves for configuring the operation of the electronic equipment located internally to containment portion 410. Adjustment mechanism 504 operates to adjust the operation of the electronic equipment located internally to containment portion 410. Non-limiting examples for the function of adjustment mechanism 504 include audio sensitivity and illumination intensity. In one embodiment, adjustment mechanism 504 may operate to control the sensitivity of microphone 502. In another embodiment, adjustment mechanism 504 may operate to control the intensity of illumination beam 424. In another embodiment the operation of adjustment mechanism 504 may be selected by verbal command or a wireless command.

FIG. 5 presents a side-view of a connection between an electro-luminance device and a shirt.

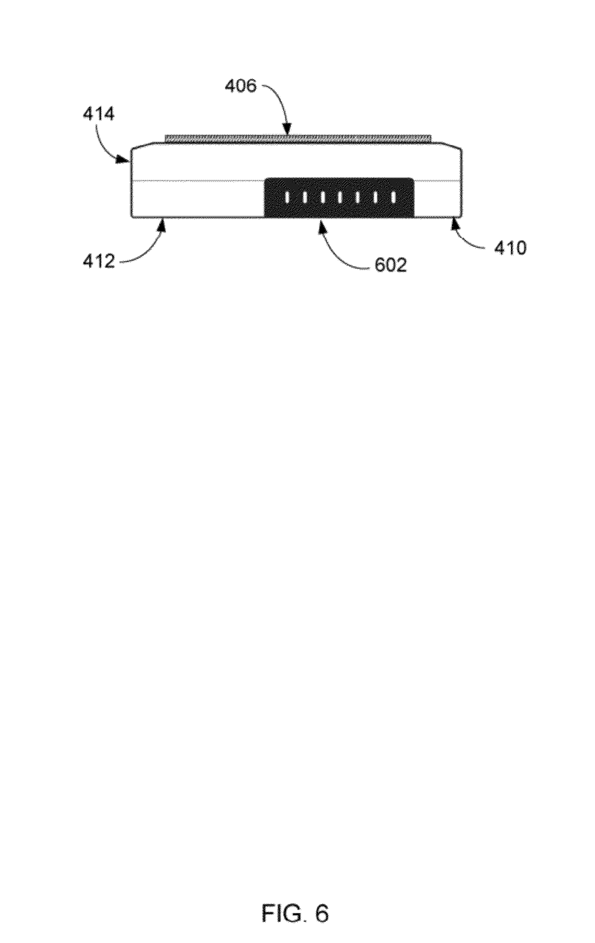

FIG. 6 presents an example bottom view as described with reference to FIG. 1 for a containment device, in accordance with an embodiment of the present invention.

Elements of FIG. 6 in common with FIGS. 4-5 will not be described for FIG. 6. For elements of FIG. 6 in common with FIGS. 4-5, the reader may refer to the discussion with reference to FIGS. 4-5.

Containment portion 410 (FIG. 4) includes a connector 602.

Connector 602 enables communication of information for the control of luminance generating portion 408 (FIG. 4) by the electronic equipment located internal to containment portion 410 (FIG. 4).

FIG. 6 presents a bottom view for a containment device.

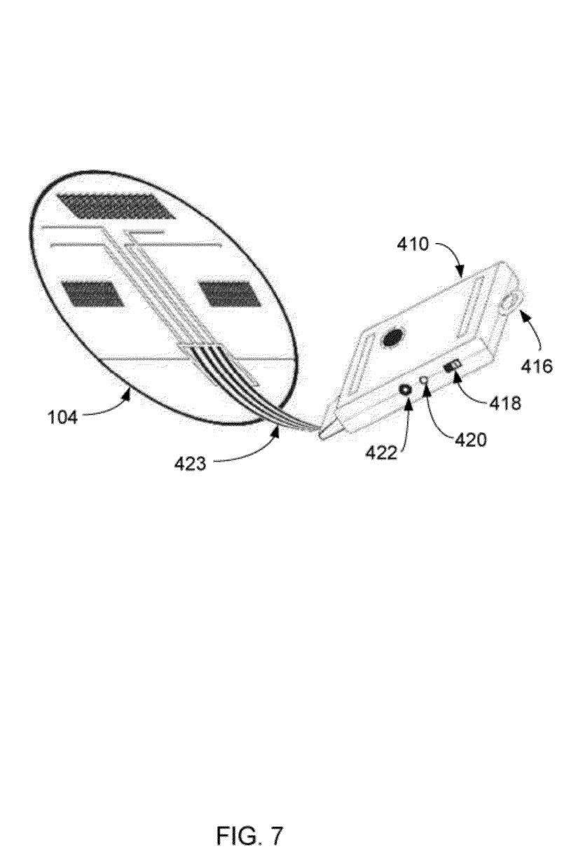

FIG. 7 illustrates an example containment portion detached from a luminance generating portion with a cable connected between the containment portion and the luminance generating portion, in accordance with an embodiment of the present invention.

Cable 423 (FIG. 4) connects the electronic equipment located internally to containment portion 410 to electro-luminance device 104 (FIG. 1). One end of cable 423 (FIG. 4) couples with connector 602 (FIG. 6).

FIG. 7. illustrates connection of a containment portion to a luminance generating portion via a cable.

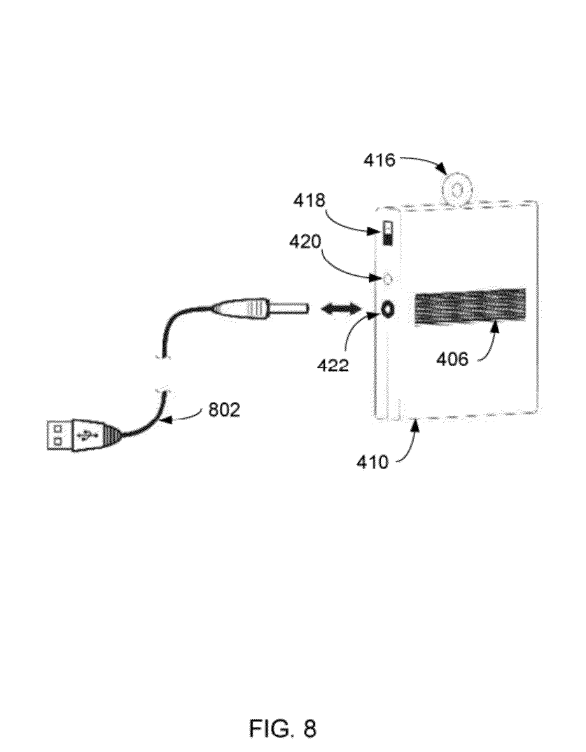

FIG. 8 illustrates an example for connecting a source of power for powering electronic equipment located internal to a containment portion and/or for charging a battery located internal to containment portion, in accordance with an embodiment of the present invention.

A cable 802 connects to power connection 422 and to a source of power (not shown). Non-limiting examples for source of power include Universal Serial Bus (USB), power supply and battery.

FIG. 8 illustrates connection of a source of power to electronic equipment for providing power and/or for charging a battery.

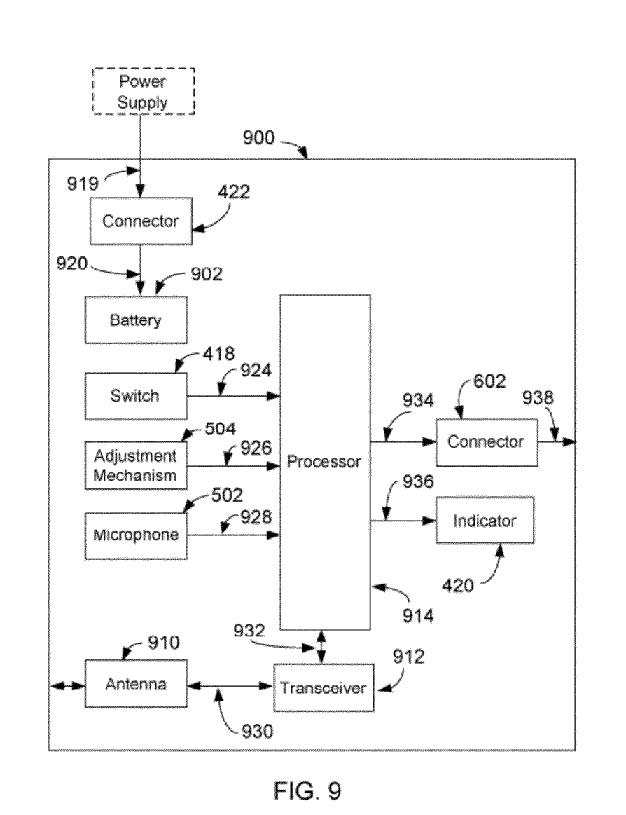

FIG. 9 illustrates an example control portion for controlling the operation of a luminance generation portion, in accordance with an embodiment of the present invention.

A control portion 900 includes switch 418 (FIG. 4), indicator portion 420 (FIG. 4), connector 602 (FIG. 6), adjustment mechanism 504 (FIG. 5), microphone 502 (FIG. 5), a battery 902, an antenna 910, a transceiver 912 and a processor 914.

Elements of FIG. 9 in common with FIGS. 4-8 will not be described for FIG. 9. For elements of FIG. 9 in common with FIGS. 4-8, the reader may refer to the discussion with reference to FIGS. 4-8.

Battery 902 operates to provide power for electronic components associated with control portion 900 and for electronic components located externally to control portion 900. As a non-limiting example, battery 902 may be lithium. Antenna 910 operates to receive and transmit information wirelessly to externally located electronic equipment. Non-limiting examples of devices which may be communicated with via antenna 910 include GPS and wireless control devices. Transceiver 912 operates to receive and transmit information wirelessly to externally located electronic equipment. Processor 914 operates to programmatically control the operation of control portion 900 and electronic equipment located external to control portion 900.

Power connection 422 receives power from a power supply located external to control portion 900 via a signal 919. Battery 902 receives power from power connection 422 for charging battery 902 via a signal 920. Battery 902 operates to provide power to electronic components associated with control portion 900 and for externally located electronic equipment. Processor 914 receives information from switch 418 via a signal 924. Processor 914 receives adjustment information from adjustment mechanism 504 via a signal 926. Processor 914 receives audio information from microphone 502 via a signal 928. Processor 914 communicates bi-directionally with transceiver 912 via a signal 932. Antenna 910 communicates bi-directionally with transceiver 912 via a signal 930. Indicator portion 420 receives information from processor 914 via a signal 936. Connector 602 receives information from processor 914 via a signal 934. Connector 602 communicates information external to control portion 900 via a signal 938.

Audio information may be received via microphone 502 for controlling the operation of control portion 900. For example, a specific clapping sequence may represent a signal to disable or enable illumination.

Sensitivity for received information maybe controlled via adjustment mechanism 504. For example, if background noise received via microphone 502 causes an error in enabling or disabling illumination, the sensitivity associated with microphone 502 may be adjusted to prevent miscellaneous background noise from enabling or disabling illumination.

Location information may be received via antenna 910 and transceiver 912 via GPS. Received location information may be used for enabling, disabling or adjusting the intensity or color of luminance. For example, for a user traveling in one direction, a particular color of luminance may be projected and for a user traveling in another direction, a different color of luminance may be projected. Furthermore, enablement or disablement of luminance may be controlled depending upon the location of a user.

The control of control portion 900 may be wirelessly controlled via an external wireless control device. For example, a device similar to devices used for alarming and de-alarming automobiles may be used for configuring the operation of control portion 900.

FIG. 9 illustrates a control portion for controlling luminance.

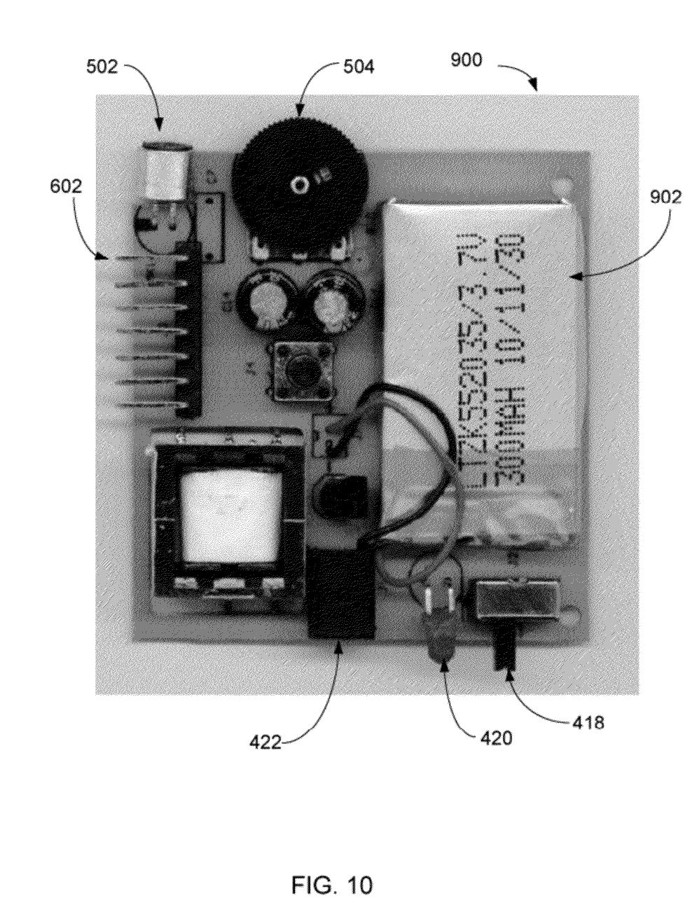

FIG. 10 presents an example photograph for a top view of a control portion, in accordance with an embodiment of the present invention.

Elements of control portion 900 presented in the photograph include switch 418, indicator portion 420, power connection 422, microphone 502, adjustment mechanism 504, microphone 502 and battery 902.

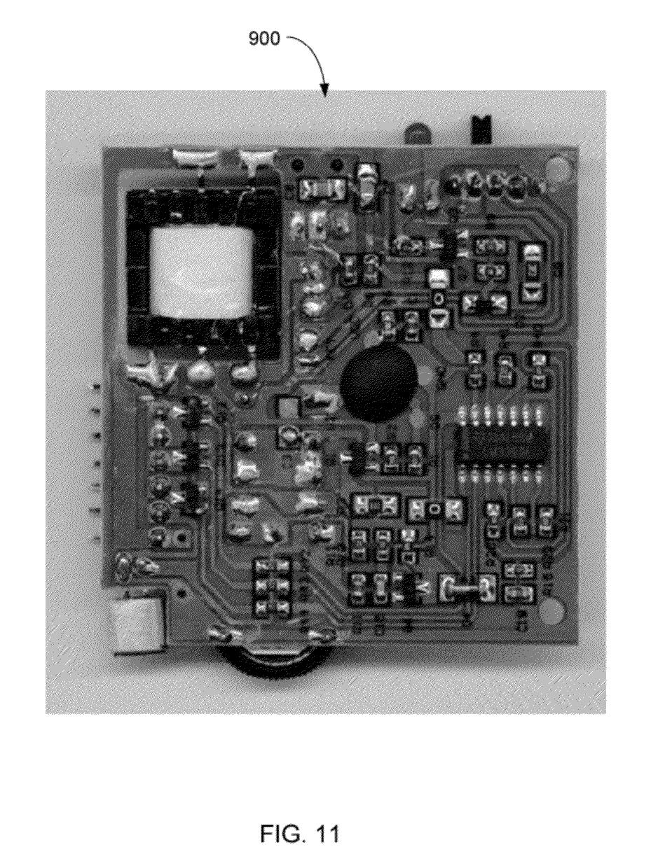

FIG. 11 presents an example photograph for a bottom view of a control portion, in accordance with an embodiment of the present invention.

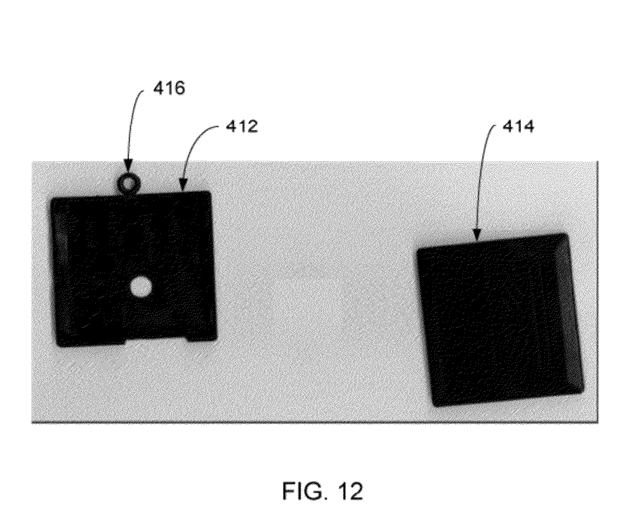

FIG. 12 presents an example photograph for elements of a containment portion, in accordance with an embodiment of the present invention.

Elements of containment portion 410 (FIG. 4) presented in the photograph include top containment portion 412 (FIG. 4), bottom containment portion 414 (FIG. 4) and loop portion 416 (FIG. 4).

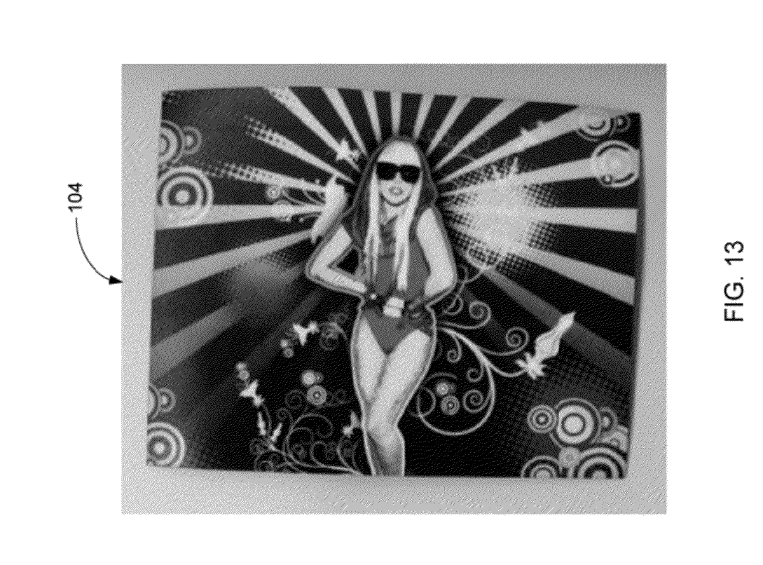

FIG. 13 presents an example photograph for the top view of the electro-luminance device as described with reference to FIG. 1.

As illustrated, electro-luminance device 104 (FIG. 1) presents an illuminated image for viewing.

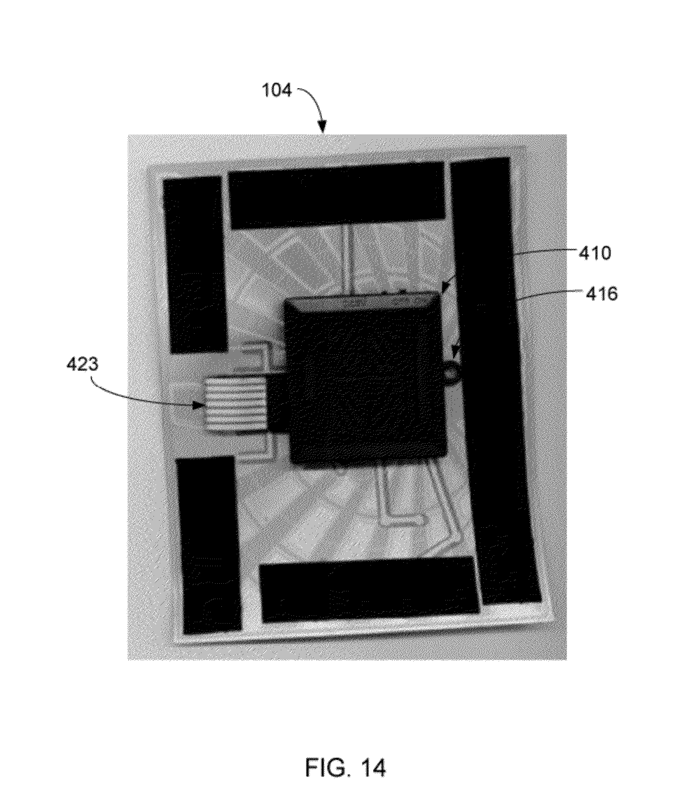

FIG. 14 presents an example photograph for the bottom view of the electro-luminance device as described with reference to FIG. 1.

Elements of electro-luminance device 104 (FIG. 1) presented in the photograph include containment portion 410 (FIG. 4), loop portion 416 (FIG. 4) and cable 423 (FIG. 4).

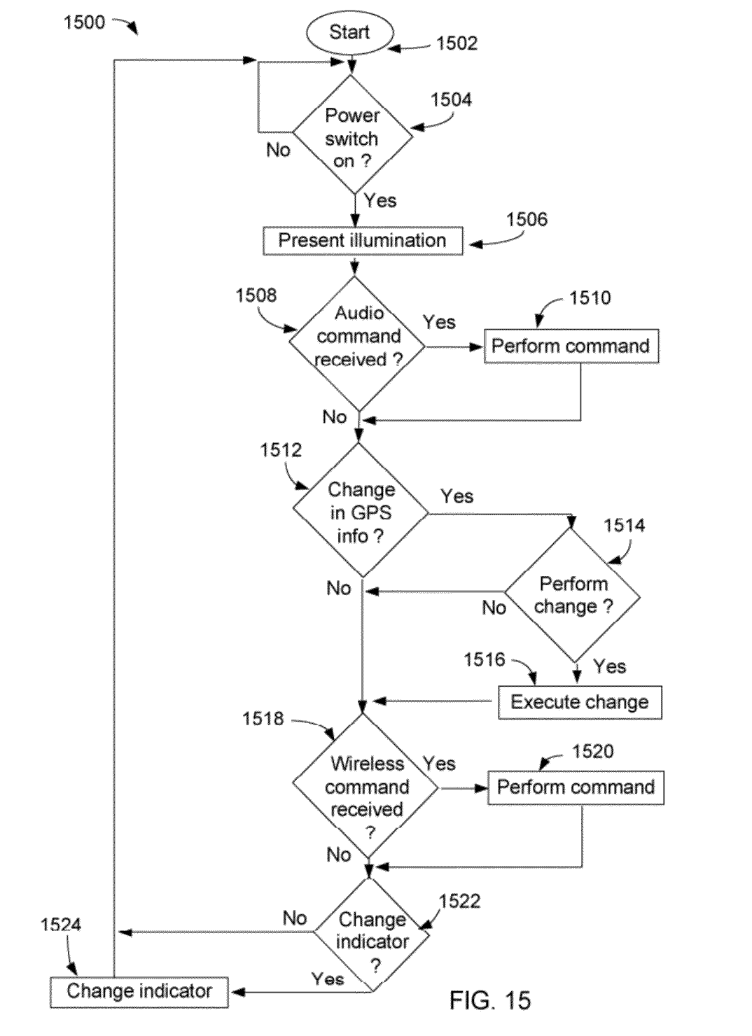

FIG. 15 illustrates an example method for operation of a electro-luminance system, in accordance with an embodiment of the present invention.

FIG. 15 presents a flow chart 1500 with a process initiating in a step 1502.

In a step 1504, it may be determined as to whether power switch (e.g. switch 418 (FIG. 4)) is configured for operation.

For a determination of power switch not figured for operation in step 1504, execution of process remains in step 1504.

For a determination of power switch configured for operation in step 1504, illumination is presented via electro-luminance system (e.g. electro-luminance system 100 (FIG. 1)) in a step 1506.

In a step 1508, a determination for receipt of an audio command may be received. Receipt of audio command may be performed by user and received by microphone (e.g. microphone 502 (FIG. 5)).

For a determination for receipt of an audio command in step 1508, audio command is performed in a step 1510. Non-limiting examples of audio commands performed include power-off, power-on, increase intensity, decrease intensity, modify color and modify presentation of illumination.

A determination for a change associated with GPS information may be performed in a step 1512. Information associated with GPS may be received by an antenna (e.g. antenna 910 (FIG. 9)) and transceiver (e.g. transceiver 912 (FIG. 9)).

For a determination of a change associated with GPS information in step 1512, a determination may be performed in a step 1514 as to whether a modification for the configuration of the electro-luminance system is to be executed.

For a determination of executing a command associated with GPS information in step 1514, a command may be performed in a step 1516. Non-limiting examples of commands performed include configuration of electro-luminance system 100 based upon the location, velocity or acceleration of a user associated with an electro-luminance system. For example, in response to a user associated with an electro-luminance system changing location, direction, velocity or acceleration, the presentation displayed by electro-luminance system may change.

A determination for receipt of a wireless command may be performed in a step 1518. Information associated with a wireless command may be received by an antenna (e.g. antenna 910 (FIG. 9)) and transceiver (e.g. transceiver 912 (FIG. 9)).

For a determination of receiving a wireless command in step 1518, received wireless command may be performed in a step 1520. Non-limiting examples of wireless commands performed include power-off, power-on, increase intensity, decrease intensity, modify color and modify presentation of illumination. Non-limiting examples of standards for performing wireless commands include Bluetooth and Wi-Fi.

A determination for changing indicator (e.g. indicator portion 420 (FIG. 4)) may be performed in a step 1522. Non-limiting examples of conditions for changing the status of indicator include low battery power, battery charging initiated, battery charging completed, power-on and power-off.

For a determination of modifying indicator in step 1522, indicator may be modified in a step 1524.

For a determination of not modifying indicator in step 1522 or following modification of indicator in step 1524, execution of process transitions to step 1504.

FIG. 15 illustrates exemplary operation of an electro-luminance system.

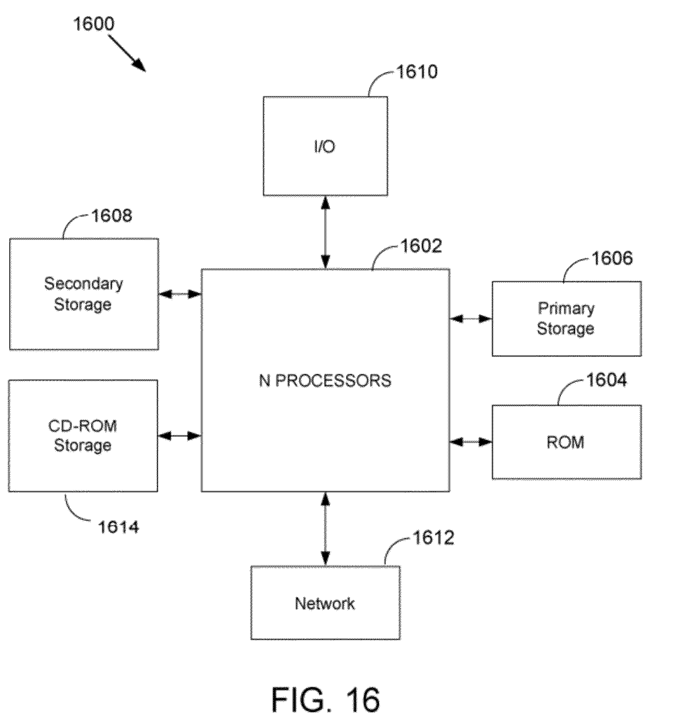

FIG. 16 illustrates a mobile device that, when appropriately configured or designed, may serve as a mobile device for which the present invention may be embodied.

A mobile device 1600 includes a quantity of processors 1602 (also referred to as central processing units, or CPUs) that may be coupled to storage devices including a primary storage 1606 (typically a random access memory, or RAM), a primary storage 1604 (typically a read only memory, or ROM). CPU 1602 may be of various types including micro-controllers (e.g., with embedded RAM/ROM) and microprocessors such as programmable devices (e.g., RISC or SISC based, or CPLDs and FPGAs) and devices not capable of being programmed such as gate array ASICs (Application Specific Integrated Circuits) or general purpose microprocessors. As is well known in the art, primary storage 1604 acts to transfer data and instructions uni-directionally to the CPU and primary storage 1606 is used typically to transfer data and instructions in a bi-directional manner. The primary storage devices discussed previously may include any suitable computer-readable media such as those described above. A mass storage device 1608 may also be coupled bi-directionally to CPU 1602 and provides additional data storage capacity and may include any of the computer-readable media described above. Mass storage device 1608 may be used to store programs, data and the like and is typically a secondary storage medium such as a hard disk. It will be appreciated that the information retained within mass storage device 1608, may, in appropriate cases, be incorporated in standard fashion as part of primary storage 1606 as virtual memory. A specific mass storage device such as a CD-ROM 1614 may also pass data uni-directionally to the CPU.

CPU 1602 may also be coupled to an interface 1610 that connects to one or more input/output devices such as such as video monitors, track balls, mice, keyboards, microphones, touch-sensitive displays, transducer card readers, magnetic or paper tape readers, tablets, styluses, voice or handwriting recognizers, or other well-known input devices such as, of course, other computers. Finally, CPU 1602 optionally may be coupled to an external device such as a database or a computer or telecommunications or internet network using an external connection shown generally as a network 1612, which may be implemented as a hardwired or wireless communications link using suitable conventional technologies. With such a connection, the CPU might receive information from the network, or might output information to the network in the course of performing the method steps described in the teachings of the present invention.

Those skilled in the art will readily recognize, in light of and in accordance with the teachings of the present invention, that any of the foregoing steps and/or system modules may be suitably replaced, reordered, removed and additional steps and/or system modules may be inserted depending upon the needs of the particular application, and that the systems of the foregoing embodiments may be implemented using any of a wide variety of suitable processes and system modules, and is not limited to any particular computer hardware, software, middleware, firmware, microcode and the like. For any method steps described in the present application that can be carried out on a computing machine, a typical computer system can, when appropriately configured or designed, serve as a computer system in which those aspects of the invention may be embodied.

All the features disclosed in this specification, including any accompanying abstract and drawings, may be replaced by alternative features serving the same, equivalent or similar purpose, unless expressly stated otherwise. Thus, unless expressly stated otherwise, each feature disclosed is one example only of a generic series of equivalent or similar features.

Having fully described at least one embodiment of the present invention, other equivalent or alternative methods of electro-luminance systems according to the present invention will be apparent to those skilled in the art. The invention has been described above by way of illustration, and the specific embodiments disclosed are not intended to limit the invention to the particular forms disclosed. For example, the particular implementation of the luminance generating portion may vary depending upon the particular type of image used. The systems described in the foregoing were directed to apparel implementations; however, similar techniques such as automotive or cycling implementations of the present invention are contemplated as within the scope of the present invention. The invention is thus to cover all modifications, equivalents, and alternatives falling within the spirit and scope of the following claims.

Claim elements and steps herein may have been numbered and/or lettered solely as an aid in readability and understanding. Any such numbering and lettering in itself is not intended to and should not be taken to indicate the ordering of elements and/or steps in the claims.

What is claimed is:

1. An apparatus comprising:
an electro-luminance portion being configured to display a graphic image, said electro-luminance portion being further configured to removably join to an outside surface of a garment;
a housing being configured to removably join to a back side of said electro-luminance portion;
a processor being contained within said housing and coupled to said electro-luminance portion, said processor being configured to execute a plurality of instructions and to control functions of said electro-luminance portion;
a transceiver system comprising an antenna and a receiver contained within said housing, said receiver being configured to at least receive GPS location information from said antenna and communicate said GPS location information to said processor where said processor is operable to control said electro-luminance portion based in part on said GPS location information; and
a rechargeable power source being contained within said housing to provide power to said electro-luminance portion and components within said housing.

2. The apparatus as recited in claim 1, further comprising a microphone system being contained within said housing, said microphone system being operable to at least detect verbal commands and communicate the verbal commands to said processor.

3. The apparatus as recited in claim 2, further comprising an adjustment mechanism being operable to signal said processor to adjust a sensitivity of said microphone system.

4. The apparatus as recited in claim 3, in which said adjustment mechanism is further operable to signal said processor to adjust a luminance output of said electro-luminance portion.

5. The apparatus as recited in claim 1, in which said processor is operable to change a presentation displayed by said electro-luminance portion in response to a location determined from said GPS information.

6. The apparatus as recited in claim 1, in which said processor is operable to change a presentation displayed by said electro-luminance portion in response to a change of location determined from said GPS information.

7. The apparatus as recited in claim 1, in which said processor is operable to change a presentation displayed by said electro-luminance portion in response to a rate of change of location determined from said GPS information.

8. The apparatus as recited in claim 1, in which said processor is operable to change a presentation displayed by said electro-luminance portion in response to a change in a rate of change of location determined from said GPS information.

9. The apparatus as recited in claim 1, in which said receiver is further configured to receive commands from a wireless device and communicate the commands to said processor.

10. The apparatus as recited in claim 1, further comprising an indicator joined to said housing for indicating a status of said rechargeable power source.

11. A system comprising:
a garment having an outside surface being visible to onlookers;
a first joining mechanism comprising a first part and a second part, said first part being joined to said outside surface;
an electro-luminance display comprising a front side and a back side, said electro-luminance display being configured to display a graphic image, said second part of said first joining mechanism being joined to said back side where said electro-luminance display is further operable to removably join to said outside surface by joining said first and second parts of said first joining mechanism;
a second joining mechanism comprising a first part and a second part, said first part being joined to said back side;
a housing comprising front portion, back portion and an interior, said second part of said second joining mechanism being joined to said front portion where said housing is further operable to removably join to said back side by joining said first and second parts of said second joining mechanism;
a processor being contained within said interior and coupled to said electro-luminance portion, said processor being configured to execute a plurality of instructions and to control functions of said electro-luminance portion;
a microphone system being contained within said interior, said microphone system being operable to at least detect verbal commands and communicate the verbal commands to said processor;
a transceiver system comprising an antenna and a receiver contained within said interior, said receiver being configured to at least receive GPS location information from said antenna and communicate said GPS location information to said processor where said processor is operable to control said electro-luminance portion based in part on said GPS location information, said receiver being further configured to receive commands from a wireless device and communicate the commands to said processor; and
a rechargeable power source being contained within said interior to provide power to said electro-luminance portion and components within said housing.

12. The system as recited in claim 11, further comprising an adjustment mechanism being operable to signal said processor to adjust a sensitivity of said microphone system.

13. The system as recited in claim 12, in which said adjustment mechanism is further operable to signal said processor to adjust a luminance output of said electro-luminance portion.

14. The system as recited in claim 11, in which said processor is operable to change a presentation displayed by said electro-luminance portion in response to a location determined from said GPS information.

15. The system as recited in claim 11, in which said processor is operable to change a presentation displayed by said electro-luminance portion in response to a change of location determined from said GPS information.

16. The system as recited in claim 11, in which said processor is operable to change a presentation displayed by said electro-luminance portion in response to a rate of change of location determined from said GPS information.

17. The system as recited in claim 11, in which said processor is operable to change a presentation displayed by said electro-luminance portion in response to a change in rate of change of location determined from said GPS information.

18. The system as recited in claim 11, further comprising an indicator joined to said housing for indicating a status of said rechargeable power source.

19. The system as recited in claim 11, further comprising a USB connection being operable to charge said rechargeable power source.

20. A method comprising steps of:
receiving an audio command where processing of the audio command results in an operational control of an electro-luminance display system being removably joined to an outside surface of a garment visible to onlookers;
receiving GPS location information where processing of the GPS location information results in a change in operational control of the electro-luminance display system; and
receiving a wireless command where processing of the wireless command results in an operational control of the electro-luminance display system.
